(19) United States
(12) Patent Application Publication
(10) Pub. No.: US 2005/0251676 A1
(43) Pub. Date: Nov. 10, 2005

(54) Method for offloading the digest portion of protocols

(75) Inventors: Hemal V. Shah, Austin, TX (US); David L. Matheny, Cedar Park, TX (US); Jeff B. Zachem, Austin, TX (US)

Correspondence Address: MARGER JOHNSON & MCCOLLOM, P.C., 210 SW MORRISON STREET, SUITE 400, PORTLAND, OR, 97204, US

(73) Assignee: Intel Corporation, Santa Clara, CA (US)

(21) Appl. No.: 10/839,816

(22) Filed: May 5, 2004

(51) Int. Cl. H04L 9/00

(52) U.S. Cl. 713/160

(57) ABSTRACT

A card receives data encoded in a protocol. The data may be divided into packets, or still in a protocol data unit. If still in a protocol data unit, the card divides the data into packets of appropriate size. Digests appropriate to the protocol are computed and inserted into the packets. Checksums are generated for the packets that need them, such as the packet now including the digest. The packets may then be transmitted to a recipient.

### FIELD

This invention pertains to packet transmission, and more particularly to computing checksums and digests for packets.

### BACKGROUND

When computers are directly connected with dedicated connections (that is, across a single connection, only two computers may communicate), communications may be done using a continuous stream of bits, and in any protocol upon which the two computers may agree. When there are no other computers accessing the connection, both computers may be sure as to which computer is the source and which is the sink of the bits in the bit stream, and both computers know exactly how to interpret the bit stream. Depending on the quality of the line, the receiving computer may receive garbled data; but if the receiving computer may detect that bits are garbled (or lost), then the receiving computer may ask the sending computer to resend the needed bits.

But where there are multiple computers connected together, any individual machine may not be able to determine from the raw data who is generating the bits and who is to receive the bits. This problem exists not only in networks where an individual server may be connected to any number of computers at a given time, but even in networks where the connections are static. For example, consider a situation where there are three computers connected A to B to C. If computer A wants to send a message to computer C, the message has to travel through computer B. But if computer B assumes that all bits it receives from either of computers A and C are intended for computer B, then there is no way for computer A to send a message to computer C without computer B. And if computer B becomes inoperable, computer A may not even ask computer B to forward a message to computer C.

The obvious solution would be to establish a direct connection between every pair of computers in the network, but this would necessitate a number of connections that grows exponentially with the number of computers on the network. Clearly, this obvious solution is impractical.

Instead of sending the data as a raw stream of bits, the bits may be stored in packets. Each packet may include a header, which provides information, such as (among others) the originating machine and the destination machine. When a computer in the network receives a packet, it only has to look at the header to determine which computer is intended to receive the packet: an intermediate computer along the network path does not have to interpret the data. One common protocol that transmits data in packets is the Transmission Control Protocol/Internet Protocol (TCP/IP), but a person skilled in the art will recognize other protocols that operate similarly.

Although it is possible to allow packets to be of any size, in practice packet size is limited to a reasonable size. That way, no one sending computer may dominate the connection with a single huge packet. But this might mean that the data being sent has to be split across multiple packets. To let the receiving computer know how to reassemble the packets in their correct order, each packet may be assigned a sequence number. If the receiving computer receives packets 1 and 3 but not packet 2, the receiving computer may request the sending computer to resend just packet 2. (Sequence numbers have the additional advantage that, if the packets arrive at the receiving computer out of order, the receiving computer may put them back in the correct order.)

To help the receiving computer verify that the data was not garbled en route, the packets may include a checksum. A checksum is an arithmetic calculation using the data in the packet. For example, a very simple checksum might just count the number of bits assigned the value “1.” The receiving computer may then re-compute the checksum upon receiving the packet. If the checksums do not match, the receiving computer may conclude that some data was garbled, and request the sending computer to resend the garbled packet.

Protocols such as TCP/IP may be used to wrap any data: even data that is in another protocol format. This ability to wrap any kind of data is one of the strengths of such a protocol. But where the data being wrapped itself is data in another protocol, a complication may arise. The other protocol may itself use a digest. (For clarity herein, the checksum included in the data (as opposed to the checksum for the packet) is called a digest. But a person skilled in the art will recognize that these terms are interchangeable.) If the data may not be transmitted “in the raw” using the other protocol (for example, the other protocol may not be guaranteed to be recognized by all possible intermediary computers), the data needs to be wrapped again in the transmission protocol (such as TCP/IP). But because protocols are standardized, the digest needs to be included in the data, even though the wrapping protocol itself uses a checksum. This means that the processor of the computer needs to compute two checksums: one for the wrapping protocol, and one (the digest) for the internal protocol.

To alleviate the burden on the processor, offload engines may be used. The offload engines are responsible for computing the digest for the internal protocol. Note that the offload engines are not responsible for computing the checksums of the wrapping protocol: this responsibility lies with the network stack of the operating system, which breaks the data to be wrapped into appropriately-sized packets. The problem is that by the time the offload engine receives the data to compute the digest, the checksums for the wrapping packets have already been computed. Computing and storing the digest into the packets now would mean that the checksums are incorrect, and the packets would be invalidated.

One solution to this problem is the so-called “Triple-Trip” solution. The data is generated in the internal protocol and sent to the offload engine. The offload engine computes the digest, and sends the data (with the computed digest) back to the processor. The operating system breaks that data into packets and computes the checksums, then sends the packets to the network hardware for transmission. The problem with this approach is that the data has to cross the bus between the processor and the hardware (i.e., the offload engine and the network hardware) three times, replacing one problem (processor use) with another (bus use).

Embodiments of the invention address these problems and others in the art.

### BRIEF DESCRIPTION OF THE DRAWINGS

FIG. 1 shows a computer connected to a network, according to an embodiment of the invention.

FIG. 2 shows a motherboard and a network interface card (NIC) of the computer of FIG. 1, according to an embodiment of the invention.

FIG. 3 shows components of the NIC of FIG. 2, according to an embodiment of the invention.

FIGS. 4A-4C show a flowchart of the procedure for performing offloaded computation of the digest for an internal protocol using the NIC of FIG. 2, according to an embodiment of the invention.

FIG. 5 shows the memory of FIG. 2, where a protocol data unit (PDU) is broken into packets for performing offloaded computation of the digest for an internal protocol using the NIC of FIG. 2, according to an embodiment of the invention.

FIG. 6 shows the insertion of computed digests/checksums for the internal and wrapping protocols using the NIC of FIG. 2, according to an embodiment of the invention.

FIG. 7 shows the insertion of a computed checksum for the wrapping protocol using the NIC of FIG. 2, according to an embodiment of the invention.

FIG. 8 shows the memory of FIG. 2, where a protocol data unit is ready for performing offloaded computation of the digest for an internal protocol using the NIC of FIG. 2, according to an embodiment of the invention.

### DETAILED DESCRIPTION OF THE PREFERRED EMBODIMENT

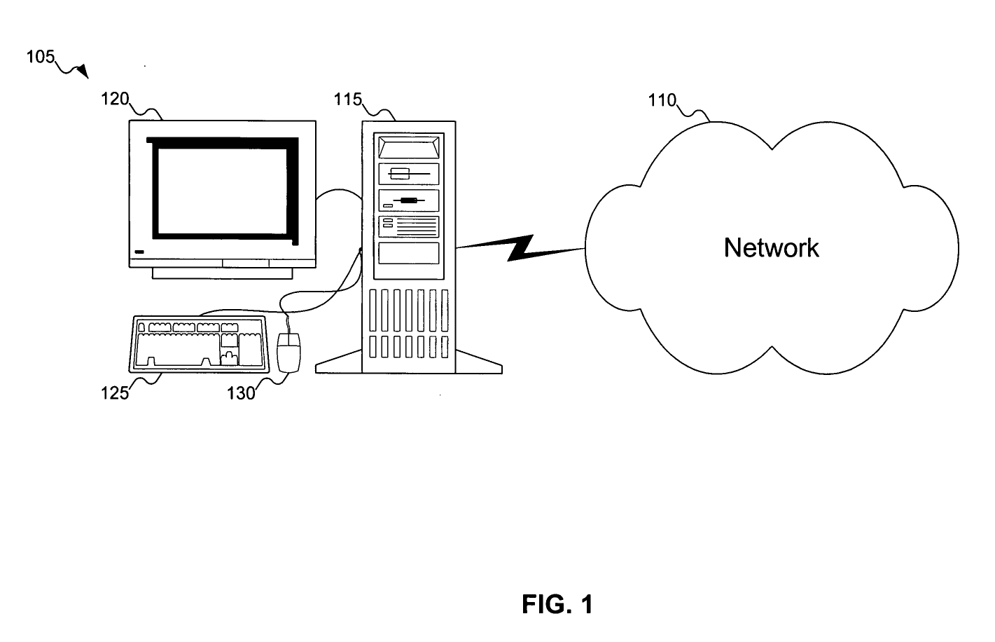

FIG. 1 shows a computer connected to a network, according to an embodiment of the invention. In FIG. 1, computer system 105 is shown connected to network 110. Computer system 105 includes computer 115, monitor 120, keyboard 125, and mouse 130, but a person skilled in the art will recognize that computer system 105 may omit components shown and may include components not shown. For example, computer system 105 might omit mouse, and include a printer.

Network 110 may be any variety of network. For example, network 110 may be an Ethernet (e.g., Megabit or Gigabit Ethernet) network, or a wireless network utilizing Bluetooth or any of the IEEE 802.11a/b/g standards, among others. (The Bluetooth standard may be found at “http:##www.bluetooth.com#dev#specifications.asp,” and the IEEE 802.11a-1999 (published in 1999), IEEE 802.11b-1999, IEEE 802.11b-1999/Cor1-2001 (published in 1999, corrected in 2001), and IEEE 802.11g-2003 (published in 2003) standards may be found online at “http:##standards.ieee.org#catalog#olis#lanman.html” (to avoid inadvertent hyperlinks, forward slashes (“/”) in the preceding uniform resource locators (URLs) have been replaced with pound signs (“#”)).

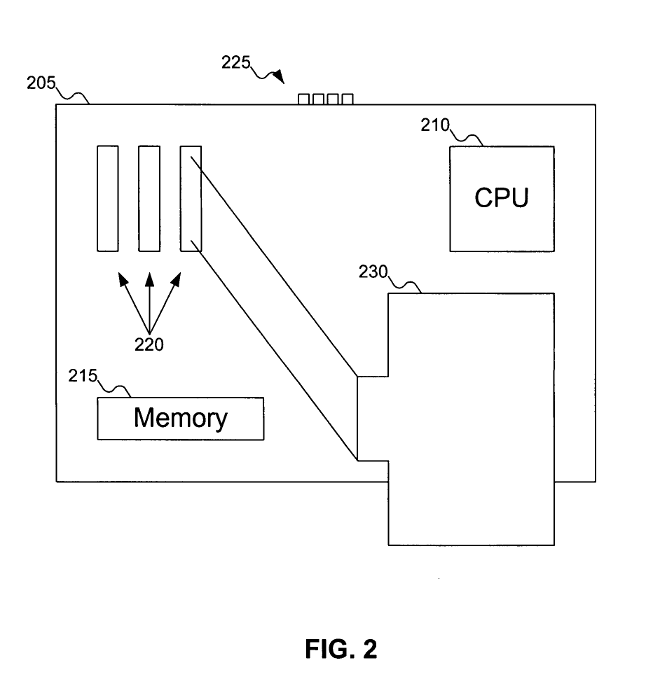

FIG. 2 shows a motherboard and a network interface card (NIC) of the computer of FIG. 1, according to an embodiment of the invention. In FIG. 2, motherboard 205 is shown. Attached to motherboard 205 are central processing unit 210, memory 215, daughterboard slots 220, and ports 225. Central processing unit 210 is the primary processor of the computer. Central processing unit 210 may be any desired processor from any manufacturer. For example, central processing unit 210 might be some flavor of Pentium® processor manufactured by Intel Corporation, although processors manufactured by any other manufacturer may be substituted. (Pentium is a trademark or a registered trademark of Intel Corporation or its subsidiaries in the United States and other countries.) Although FIG. 2 shows motherboard 205 with only a single processor, a person skilled in the art will recognize that embodiments of the invention are equally applicable to multi-processor systems.

Memory 215 is the main memory of the computer. Slots 220 provide locations for daughterboards to be coupled to motherboard 205, thereby enhancing the functionality of the computer. Ports 225 are ports provided on motherboard 205. For example, ports 225 might be input ports (e.g., connectors for a keyboard or mouse), output ports (e.g., a parallel port or universal serial bus (USB) port for a printer), or any other variety of port. Other uses for ports 225 might include ports to connect a scanner, an RJ-11 telephone jack to connect a telephone wire for use of a modem, or an IEEE 1394 connector (commonly called FireWire®, a registered trademark of Apple Corporation. The IEEE 1394-1995/1394a-2000/1394b-2002 (published in 1995, amended in 2000 and 2002) standards may be found online at “http:##standards.ieee.org#catalog#olis#busarch.html”).

FIG. 2 also shows daughterboard 230, which is a network interface card (NIC) according to an embodiment of the invention. In the described embodiment, motherboard 205 either does not have a network port (e.g., an Ethernet port) for connecting the computer to a network, or else that port (one of ports 225) is disabled in favor of a port on NIC 230. But a person skilled in the art will recognize that other embodiments are possible. For example, NIC 230 might not have a network port; NIC 230 might only perform the digest computation, leaving transmission to the network port on motherboard 205 (or on another daughterboard).

Although FIG. 2 shows an embodiment of the invention implemented as daughterboard 230, a person skilled in the art will recognize that other embodiments are possible. For example, NIC 230 might be implemented as a LAN on motherboard (LOM) controller on motherboard 205, using one of ports 225 to connect to the network. NIC 230 might also be integrated into the chipset or central processing unit (CPU) core on motherboard 205.

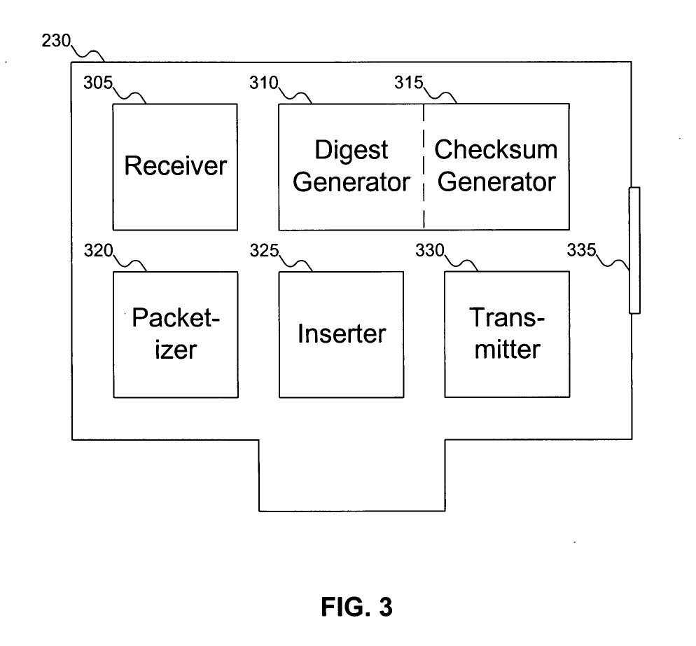

FIG. 3 shows components of the NIC of FIG. 2, according to an embodiment of the invention. NIC 230 includes receiver 305, digest generator 310, checksum generator 315, packetizer 320, inserter 325, and transmitter 330. NIC 230 also includes port 335, which provides the point of coupling to the network. Port 335 may be a physical point of connection (e.g., to receive an Ethernet cable), a wireless connection point, or any other desired port for sending and receiving traffic out onto a network.

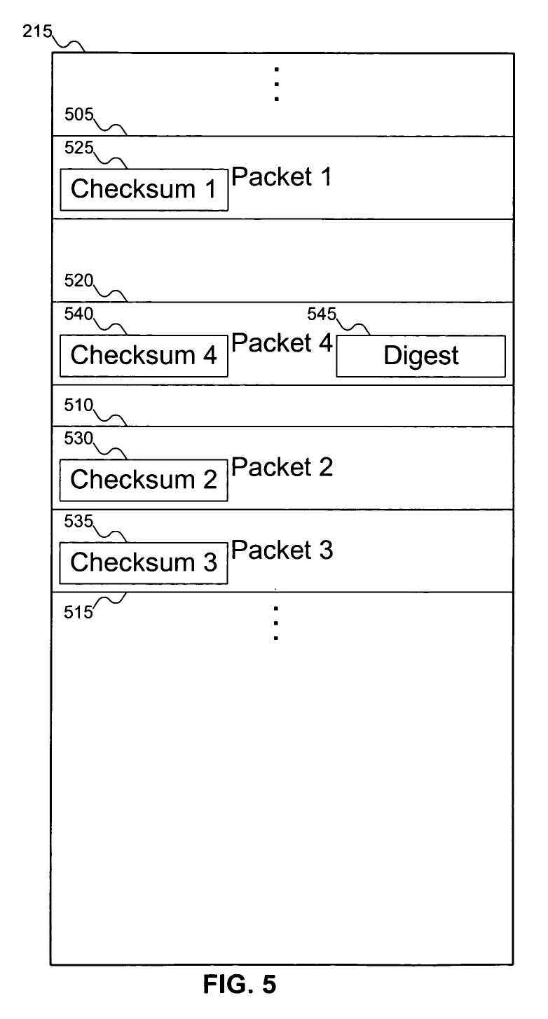

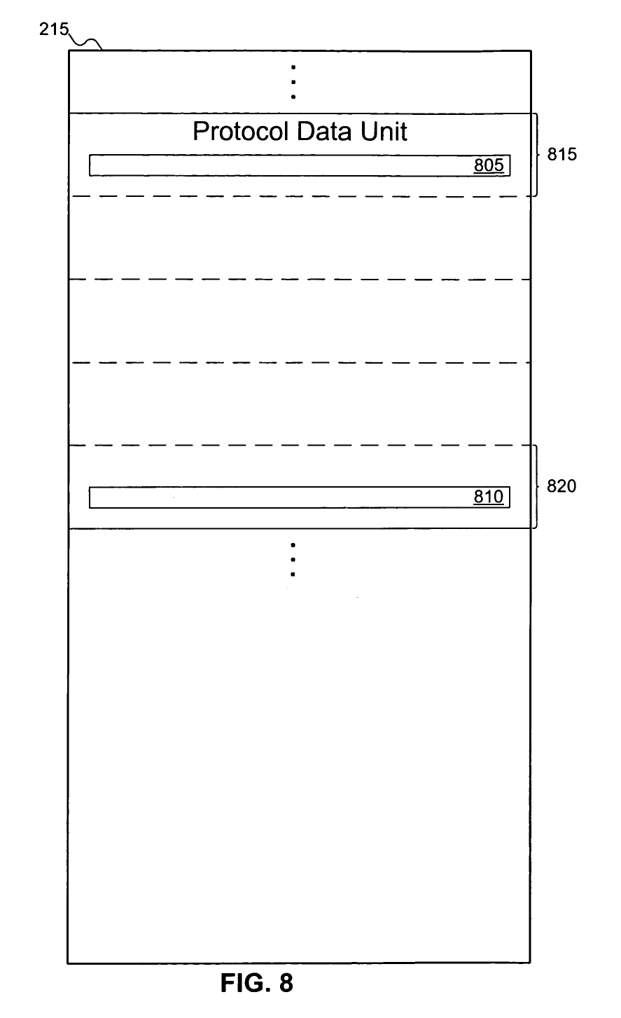

Receiver 305 receives data for which the digest is to be computed. As will be discussed below with reference to FIGS. 5 and 8, typically NIC 230 receives memory addresses storing the data (either already in packet form or ready to be put into packets), and accesses the data from memory, but a person skilled in the art will recognize that other techniques may be used. For example, receiver 305 might receive the data directly from an application program generating the data, without the data being stored in memory first.

Digest generator 310 and checksum generator 315 respectively generate digests and checksums. As discussed above, the terms “digest” and “checksum” are interchangeable, which is why digest generator 310 and checksum generator 315 are shown together in a combined block. But typically different protocols are used to encode the data in the inner protocol and the wrapping protocol, so digest generator 310 and checksum generator 315 may use different algorithms. Thus, in order to compute the digest/checksum, NIC 230 knows the protocols used to deliver the data. If the wrong algorithm is used to compute the digest/checksum, the data will be rejected even if there is no error in delivery of the packets. NIC 230 may learn the appropriate algorithm to use in several ways. One way to address this issue is for NIC 230 to be designed so that it is only able to generate digests/checksums using specific algorithms. Another way is for NIC 230 to be programmed with a variety of algorithms and be instructed by the software generating the data as to which algorithm to use. A third approach is for NIC 230 to receive from the software generating the data the specific algorithms to use. A person skilled in the art will recognize other ways in which NIC 230 may know which digest/checksum generating algorithm to use.

Another point worth recognizing is the different amounts of data upon which digest generator 310 and checksum generator 315 operate. Checksum generator 315 generates a checksum for each individual packet. That way, if the packet is garbled in transmission, the receiving computer may detect the problem and request re-transmission of that individual packet. (If the checksum algorithm includes error-correcting codes, re-transmission might not be necessary, as the receiving computer may be able to correct the errors.) But digest generator 310 may generate digests for various amounts of data that may be of a different size than a single packet. For example, digest generator 310 may generate a single digest for a protocol data unit. A protocol data unit (PDU) is the assemblage of all of the data pertinent to a particular transmission for the internal protocol. The maximum size of the PDU is dependent on the particular protocol, and may exceed the maximum size for a packet (which is why the PDU may be broken into multiple packets). Thus, digest generator 310 generates a single digest, even if the PDU is broken into multiple packets. (As mentioned above, the number of digests required by a particular protocol may vary. For example, some protocols require two digests: one for the data, and one for a header for the data, whereas other protocols may require multiple digests spanning various portions of the data in the PDU.)

To be clear, three different terms are used to refer to the different types of digests. A data digest is a digest of the data in the PDU. A header digest is a digest of the header in the PDU. A digest generally, without the introductory “data” or “header,” refers to either a data digest or a header digest, or to a digest of both data and header in the PDU.

A third point of interest lies in the presence (or absence) of the packet checksums. The software generating the data, if it breaks the PDU into packets, may generate the checksums or leave them blank. If checksums are provided, then the NIC does not have to compute them (except for the packets receiving digests, for which the previously-computed checksums will be incorrect). If checksums are omitted, then NIC may generate them. If the checksums are omitted, space should be left for them in the packets, so that the packets do not need to be resized when the checksums are added.

There are numerous internal protocols that might be used with embodiments of the invention. A prime example is iSCSI (Internet Small Computer Systems Interface), a storage networking standard. iSCSI includes both a data digest and a header digest, so digest generator 310 would generate two digests when the iSCSI protocol is used. Other example internal protocols with which embodiments of the invention may be used include NFS (Network File System) and CIFS (Common Internet File System). A person skilled in the art will recognize still other protocols for which digest generator 310 is used.

A further point of interest lies in the order of computation for digest generator 310 and checksum generator 315. In general, digest generator 310 and checksum generator 315 operate in parallel. But where a packet is to include a digest, the digest needs to be computed and added to the packet before the checksum is computed. Otherwise, the checksum will be incorrect.

Packetizer 320 is responsible for breaking the data into packets, provided that the data has not already been divided into packets. As will be discussed further below with reference to FIGS. 5 and 8, the data may be received by receiver 305 from the computer (typically, from the host stack of the operating system installed on the computer) for transmission on the network already broken into packets, or still in the PDU. If the data is received in the PDU and the PDU is larger than a single packet, packetizer 320 breaks the PDU into a number of packets (each packet of an appropriate size for the wrapping protocol) and adds the appropriate header information (except for the checksum).

Whether the PDU for network transmission is received in packets or packetizer 320 generates the packets, the PDU leaves a space for where the digest(s) will go. Anything may be put into this space: typically, it is left blank (since it will be overwritten when the digest is computed). If space is not left for the digest(s), then the packet(s) containing the digests will need to be resized, and that might affect the division of the PDU across the packets. Similarly, the checksums may be left blank, in which case the NIC uses checksum generator 315 to compute the checksums.

Inserter 325 is responsible for receiving from digest generator 310 and checksum generator 315 the computed digests/checksums, and inserting them in the appropriate places in the packets. Finally, transmitter 330 is responsible for transmitting the packets across the network across port 335.

In one embodiment, digest generator 310 and checksum generator 315 operate as data is retrieved from memory and being transmitted. That is, as packets are read (or generated using packetizer 320), checksum generator 315 generates checksums for the packets. The generated checksums are added to the packets by inserter 325, and the packets are transmitted. In parallel, digest generator 310 reads the data out of the packets and generates a digest (or more than one digest, as required by the protocol) for the PDU. (If the data is broken across multiple packets, digest generator 310 may store intermediate results until the entire PDU has been transmitted.) If a digest is inserted into a packet, this insertion is performed before checksum generator 315 computes a checksum for that packet, so that the checksum is also correct.

Although the above description suggests that NIC 230 only operates to process outgoing data (and not incoming data), this is not necessarily the case. All that needs to be done is to compute checksums to verify the integrity of the individual packets, and then compute the digest(s) to verify the overall integrity of the PDU. If NIC 230 is to verify the integrity of the packets and the PDU, then NIC 230 uses digest generator 310 and checksum generator 315 to compute the digests/checksums. A comparator (not shown in FIG. 3) compares the computed digests/checksums with those retrieved from the packets/PDU. If the comparator indicates an error in transmission, then the sending computer may be requested to resend the appropriate packet(s) (or the entire PDU, if there was a problem only with the digest and not with any of the checksums).

One basic approach to using NIC 230 would be as follows. NIC 230 computes the digest(s) needed for the protocol for the PDU, and inserts the digest(s) into the appropriate places in the PDU. NIC 230 then divides the PDU into the appropriate number of packets (dependent on the maximum packet size). The packets are constructed using the appropriate PDU data (and/or PDU header data, if the packet in question includes PDU header data) and the appropriate packet header information. Checksums are added to the packets, and the packets are transmitted across the network connection. NIC 230 may then return a completion status for the transmission of the PDU.

A person skilled in the art will recognize other variations from the basic approach discussed above. As discussed earlier, NIC 230 may receive the PDU already divided into packets, stored in memory as a single PDU, or directly from the application generating the PDU. A person skilled in the art will recognize how the basic approach may be modified to accommodate these and other variations.

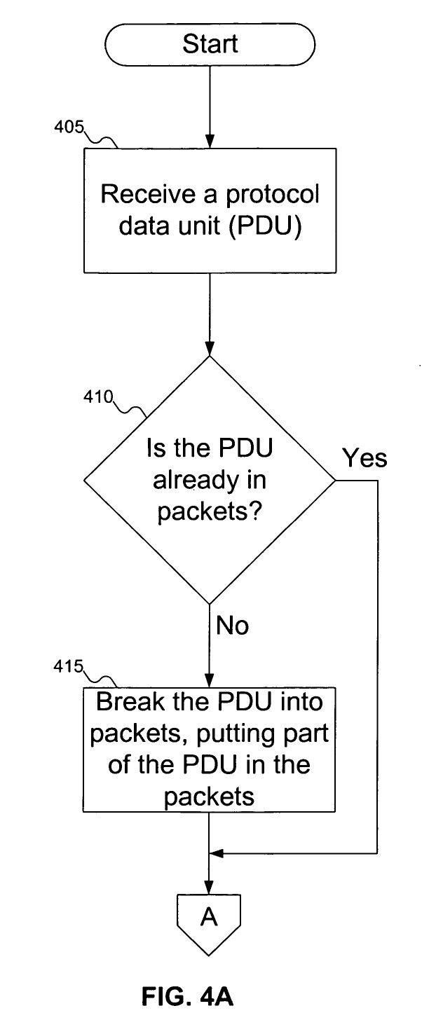

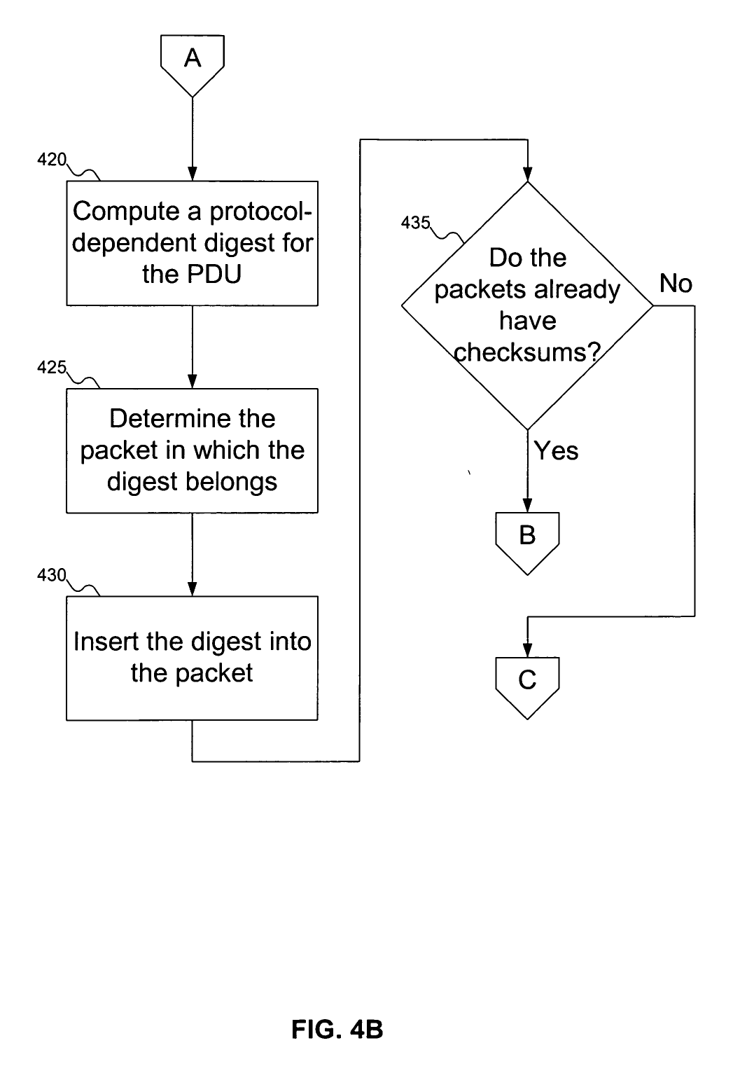

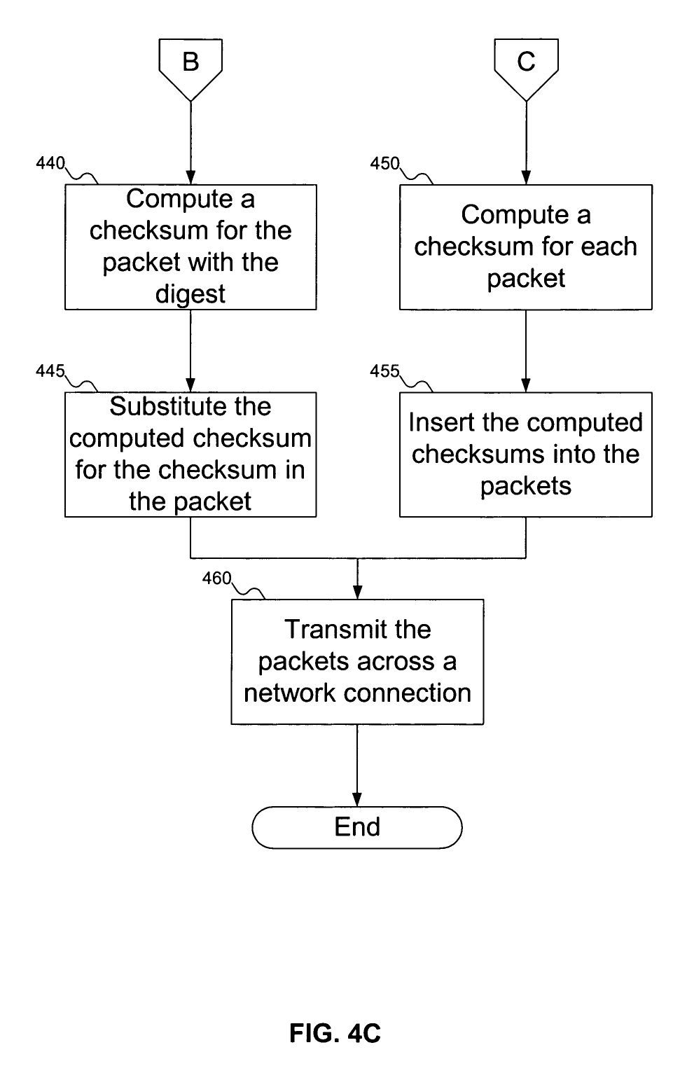

FIGS. 4A-4C show a flowchart of the procedure for performing offloaded computation of the checksum for an internal protocol using the NIC of FIG. 2, according to an embodiment of the invention. In FIG. 4A, at block 405, the NIC receives a PDU. At block 410, the NIC checks to see if the PDU is already in packets. If not, then at block 415, the NIC packetizes the PDU into the appropriate number of packets, supplying the appropriate header information for each packet. (Note that if the PDU is small enough, only one packet might be needed.)

At block 420 (FIG. 4B), the NIC computes a digest for the PDU. As discussed above with reference to FIG. 3, there protocol may require more than one digest, in which case multiple digests are computed/inserted, as appropriate. At block 425, the NIC determines the packet into which the digest belongs. At block 430, the digest is inserted into the appropriate packet. As described above with reference to FIG. 3, the packet in question includes a space for the digest, even though it had not been computed before.

At block 435, the NIC checks to see if checksums have been computed for the packets. If checksums have already been generated, then at block 440 (FIG. 4C) checksums are generated only for the packet including the (now computed) digest, and at block 445 the computed checksum is inserted into the packet to replace the (now incorrect) checksum. Otherwise, at block 450, the NIC computes a checksum for each packet, and at block 455 the checksums are inserted into the packets. Either way, at block 460, the packets are then transmitted to their destination.

Although FIGS. 4A-4C suggest that the digest is computed first, then the checksums are computed as appropriate, as discussed above with reference to FIG. 3, this is typically not the case. Instead, as discussed above with reference to FIG. 3, the checksums may be computed as each packet is examined, rather than at the end. FIGS. 4A-4C are drawn in their current form for simplicity of representation (and because they represent an alternate embodiment of the invention).

Although FIGS. 4A-4C suggest that the digests and checksums are computed before the transmission of packets, this is typically not the case. Instead, the computation of the digest may be overlapped with the transmission of the packets that do not carry the digest. Similarly, the computation of the checksum of a packet may be overlapped with the transmission of other packets.

FIG. 5 shows the memory of FIG. 2, where a protocol data unit (PDU) is broken into packets for performing offloaded computation of the checksum for an internal protocol using the NIC of FIG. 2, according to an embodiment of the invention. In FIG. 5, memory 215 is shown with four packets 505, 510, 515, and 520, scattered in memory 215. (Although FIG. 5 shows four packets, a person skilled in the art will recognize that memory 215 may hold any number of packets.) To receive the packets, the NIC receives the base memory address (and size, if the packets are not of a uniform size) of each packet.

Although FIG. 5 shows the packets as being randomly arranged in memory 215, a person skilled in the art will recognize that other arrangements are possible: for example, that all the packets are contiguous in memory. In that case, the NIC only needs the starting address of each packet and the size of the last packet (if packets are not of uniform size), or even just the starting memory address and the number of packets (if the packets are of uniform size).

Each of packets 505, 510, 515, and 520 includes checksums 525, 530, 535, and 540, respectively. Packet 520 also includes digest 545. (Although FIG. 5 only shows one digest, as discussed above, the internal protocol may require more than one digest; a person skilled in the art will recognize how FIG. 5 would be modified for multiple digests.) As discussed above with reference to FIG. 3, checksums 525, 530, 535, and 540 may already be computed, or simply placeholders for checksums to be computed by the NIC (according to embodiments of the invention, digest 545 is not pre-computed).

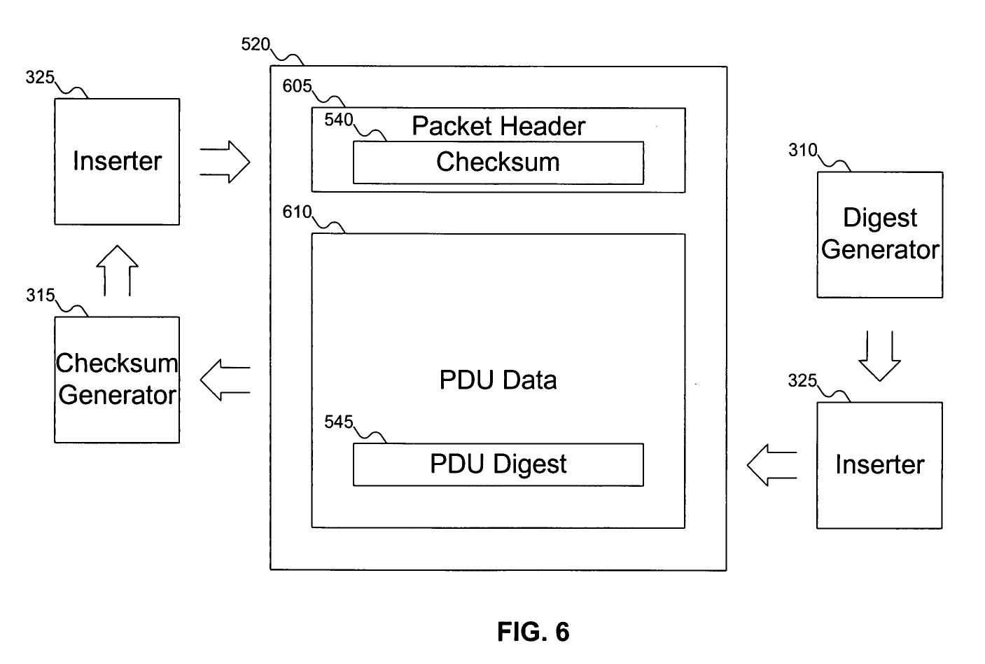

FIG. 6 shows the insertion of computed checksums for the internal and wrapping protocols using the NIC of FIG. 2, according to an embodiment of the invention. FIG. 6 shows the operation of elements of the NIC of FIG. 2 on packet 520 of FIG. 5. Packet 520 includes packet header 605, which has space for checksum 540, and packet data 610, which has space for digest 545. Digest generator 310 generates a digest, which is inserted into packet data 610 by inserter 325 as digest 545. Checksum generator 315 computes a checksum, which is also inserted into packet header 605 by inserter 325 as checksum 540.

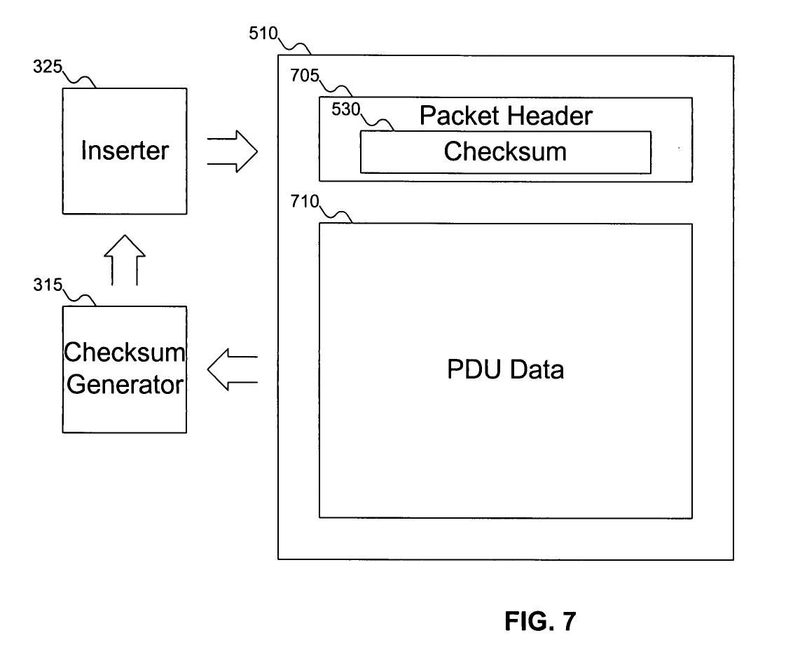

For comparison, FIG. 7 shows the insertion of a computed checksum for the wrapping protocol using the NIC of FIG. 2, according to an embodiment of the invention. In FIG. 7, packet 510 of FIG. 5 is shown. As with packet 520, packet 510 includes packet header 705 and packet data 710. Packet header 705 includes space for checksum 530. Note that in packet 510, no digest is shown in the data, and so no digest needs to be generated for packet 510. (The data in packet data 710 is still read for use in generating the digest; it is simply that the digest is not inserted into packet 510.) Checksum generator 315 may generate a checksum, which is inserted into packet header 705 as checksum 530 by inserter 325.

Whereas FIG. 5 showed the PDU already broken into packets before being delivered to the NIC, FIG. 8 shows the memory of FIG. 2 storing a PDU. The PDU includes space for header digest 805 and data digest 810. All that the NIC needs to know is the memory address(es) of the PDU and its size. (There may be multiple memory addresses for the PDU, if the PDU is not stored in a contiguous block of memory.) The NIC may then generate the digest and header digest for insertion into the appropriate packets. The packetizer breaks the PDU into appropriately sized chunks of data for packet transmission. For example, header digest 805 ends up in packet 815, whereas the digest ends up in packet 820.

The following discussion is intended to provide a brief, general description of a suitable machine in which certain aspects of the invention may be implemented. Typically, the machine includes a system bus to which is attached processors, memory, e.g., random access memory (RAM), read-only memory (ROM), or other state preserving medium, storage devices, a video interface, and input/output interface ports. The machine may be controlled, at least in part, by input from conventional input devices, such as keyboards, mice, etc., as well as by directives received from another machine, interaction with a virtual reality (VR) environment, biometric feedback, or other input signal. As used herein, the term “machine” is intended to broadly encompass a single machine, or a system of communicatively coupled machines or devices operating together. Exemplary machines include computing devices such as personal computers, workstations, servers, portable computers, handheld devices, telephones, tablets, etc., as well as transportation devices, such as private or public transportation, e.g., automobiles, trains, cabs, etc.

The machine may include embedded controllers, such as programmable or non-programmable logic devices or arrays, Application Specific Integrated Circuits, embedded computers, smart cards, and the like. The machine may utilize one or more connections to one or more remote machines, such as through a network interface, modem, or other communicative coupling. Machines may be interconnected by way of a physical and/or logical network, such as an intranet, the Internet, local area networks, wide area networks, etc. One skilled in the art will appreciated that network communication may utilize various wired and/or wireless short range or long range carriers and protocols, including radio frequency (RF), satellite, microwave, Institute of Electrical and Electronics Engineers (IEEE) 802.11, Bluetooth, optical, infrared, cable, laser, etc.

The invention may be described by reference to or in conjunction with associated data including functions, procedures, data structures, application programs, etc. which when accessed by a machine results in the machine performing tasks or defining abstract data types or low-level hardware contexts. Associated data may be stored in, for example, the volatile and/or non-volatile memory, e.g., RAM, ROM, etc., or in other storage devices and their associated storage media, including hard-drives, floppy-disks, optical storage, tapes, flash memory, memory sticks, digital video disks, biological storage, etc. Associated data may be delivered over transmission environments, including the physical and/or logical network, in the form of packets, serial data, parallel data, propagated signals, etc., and may be used in a compressed or encrypted format. Associated data may be used in a distributed environment, and stored locally and/or remotely for machine access.

Having described and illustrated the principles of the invention with reference to illustrated embodiments, it will be recognized that the illustrated embodiments may be modified in arrangement and detail without departing from such principles. And, though the foregoing discussion has focused on particular embodiments, other configurations are contemplated. In particular, even though expressions such as “in one embodiment” or the like are used herein, these phrases are meant to generally reference embodiment possibilities, and are not intended to limit the invention to particular embodiment configurations. As used herein, these terms may reference the same or different embodiments that are combinable into other embodiments.

Consequently, in view of the wide variety of permutations to the embodiments described herein, this detailed description and accompanying material is intended to be illustrative only, and should not be taken as limiting the scope of the invention. What is claimed as the invention, therefore, is all such modifications as may come within the scope and spirit of the following claims and equivalents thereto.

1. A network interface card, comprising:
a receiver to receive a protocol data unit for transmission on a network;
a digest generator to generate a digest for said protocol data unit;
a checksum generator to generate a checksum for a first packet, said first packet including at least a first portion of said protocol data unit and a place for said digest;
an inserter to insert said digest and said checksum into said first packet;
a port to connect to said network; and
a transmitter to transmit at least said first packet across said network via the port.

2. A network interface card according to claim 1, further comprising a packetizer to break said protocol data unit into packets and assign said first portion of said protocol data unit to said first packet.

3. A network interface card according to claim 1, wherein the receiver is operative to receive said protocol data unit in packets.

4. A network interface card according to claim 1, wherein the receiver is operative to receive a memory address and a size for the protocol data unit.

5. A network interface card according to claim 1, wherein said digest is a data digest of a data of said protocol data unit.

6. A network interface card according to claim 5, wherein the digest generator is further operative to generate a header digest for a header of said protocol data unit.

7. A network interface card according to claim 6, wherein the inserter is operative to insert said data digest and said header digest into said first packet.

8. A network interface card according to claim 6, wherein the inserter is operative to insert said data digest into said first packet and to insert said header digest into a second packet.

9. A network interface card according to claim 1, wherein the inserter is operative to insert said checksum into said first packet.

10. A network interface card according to claim 1, wherein the inserter is operative to replace an old checksum in said first packet with said checksum.

11. An apparatus, comprising:
a receiver to receive a protocol data unit for transmission on a network;
a digest generator to generate a digest for said protocol data unit;
a checksum generator to generate a checksum for a first packet, said first packet including at least a first portion of said protocol data unit and a place for said digest; and
an inserter to insert said digest and said checksum into said first packet.

12. An apparatus according to claim 11, further comprising a transmitter to transmit at least said first packet.

13. An apparatus according to claim 11, further comprising a packetizer to break said protocol data unit into packets and assign said first portion of said protocol data unit to said first packet.

14. An apparatus according to claim 11, wherein the receiver is operative to receive said protocol data unit in packets.

15. An apparatus according to claim 11, wherein said digest is a data digest of a data of said protocol data unit.

16. An apparatus according to claim 15, wherein the digest generator is further operative to generate a header digest for a header of said protocol data unit.

17. An apparatus according to claim 11, wherein the inserter is operative to replace an old checksum in said first packet with said checksum.

18. A system, comprising:
a processor;
a memory coupled to the processor; and
a network interface card communicating with the processor and the memory, the network interface card including:
a receiver to receive a protocol data unit for transmission on a network;
a digest generator to generate a digest for said protocol data unit;
a checksum generator to generate a checksum for a first packet, said first packet including at least a first portion of said protocol data unit and a place for said digest; and
an inserter to insert said digest and said checksum into said first packet.

19. A system according to claim 18, the network interface card further comprising a packetizer to break said protocol data unit into packets and assign said first portion of said protocol data unit to said first packet.

20. A system according to claim 18, wherein:
the memory includes said protocol data unit beginning at a memory address, said protocol data unit having a size; and
the receiver is operative to receive said memory address and said size for said protocol data unit.

21. A system according to claim 20, wherein the memory includes said protocol data unit in packets.

22. A system according to claim 18, wherein:
the system further comprises a network coupled to the network interface card; and
the network interface card further includes a transmitter to transmit at least said first packet

23. A system according to claim 18, wherein said digest is a data digest of a data of said protocol data unit.

24. A system according to claim 23, wherein the digest generator is further operative to generate a header digest for a header of said protocol data unit.

25. A method for a network interface card to compute a digest for a protocol data unit in a protocol, comprising:
receiving the protocol data unit for transmission on a network;
computing a digest for the protocol data unit;
inserting the digest into a first packet, the first packet including at least a first portion of the protocol data unit;
computing a checksum for the first packet; and
inserting the computed checksum into the first packet.

26. A method according to claim 25, further comprising transmitting at least the first packet across the network coupled to the network interface card.

27. A method according to claim 25, further comprising placing at least the first portion of the protocol data unit into the first packet.

28. A method according to claim 27, further comprising placing a second portion of the protocol data unit into a second packet.

29. A method according to claim 27, further comprising:
computing a second checksum for the second packet; and
inserting the second computed checksum into the second packet.

30. A method according to claim 25, wherein receiving the protocol data unit includes receiving the first packet including at least the first portion of the protocol data unit.

31. A method according to claim 30, wherein receiving the protocol data unit further includes receiving a second packet including a second portion of the protocol data unit.

32. A method according to claim 30, wherein:
receiving the first packet includes receiving an old checksum for the first packet; and
inserting the computed checksum into the first packet includes replacing the old checksum with the computed checksum.

33. A method according to claim 25, wherein receiving the protocol data unit includes receiving a memory address and a size for the protocol data unit.

34. A method according to claim 25, wherein:
computing a digest includes computing a data digest for a data of the protocol data unit; and
inserting the digest includes inserting the data digest into the first packet.

35. A method according to claim 34, further comprising computing a header digest for a header of the protocol data unit.

36. A method according to claim 35, further comprising inserting the header digest into the first packet.

37. A method according to claim 35, further comprising inserting the header digest into a second packet.

38. A method according to claim 37, further comprising:
computing a second checksum for the second packet; and
inserting the second computed checksum into the second packet.

39. A method according to claim 25, wherein:
computing a digest includes computing a protocol-dependent digest for the protocol data unit; and
inserting the digest includes inserting the protocol-dependent digest into the first packet.

40. A method according to claim 25, wherein inserting the digest includes determining a position for the digest within the protocol data unit, the position determined using the protocol and a size for the protocol data unit.

41. A method according to claim 25, the method operable by a network interface card (NIC).

42. An article comprising:
a storage medium, said storage medium having stored thereon instructions, that, when executed by a network interface card in a machine, result in:
receiving a protocol data unit for transmission on a network;
computing a digest for the protocol data unit;
inserting the digest into a first packet, the first packet including at least a first portion of the protocol data unit;
computing a checksum for the first packet; and
inserting the computed checksum into the first packet.

43. An article according to claim 42, the storage medium having stored thereon further instructions, that, when executed by the network interface card, result in placing at least the first portion of the protocol data unit into the first packet.

44. An article according to claim 43, the storage medium having stored thereon further instructions, that, when executed by the network interface card, result in:
computing a second checksum for the second packet; and
inserting the second computed checksum into the second packet.

45. An article according to claim 42, wherein receiving the protocol data unit includes receiving the first packet including at least the first portion of the protocol data unit.

46. An article according to claim 45, wherein:
receiving the first packet includes receiving an old checksum for the first packet; and
inserting the computed checksum into the first packet includes replacing the old checksum with the computed checksum.

47. An article according to claim 42, wherein inserting the digest includes determining a position for the digest within the protocol data unit, the position determined using the protocol and a size for the protocol data unit.
